(19) United States
(12) Patent Application Publication
(10) Pub. No.: US 2024/0168467 A1
(43) Pub. Date: May 23, 2024

(54) Computer-Implemented Methods Referring to an Industrial Process for Manufacturing a Product and System for Performing Said Methods

(71) Applicant: ABB Schweiz AG, Baden (CH)

(72) Inventors: Arzam Kotriwala, Ladenburg (DE); Nuo Li, Mannheim (DE); Jan-Christoph Schlake, Darmstadt (DE); Prerna Juhlin, Heidelberg (DE); Felix Lenders, Darmstadt (DE); Matthias Biskoping, Hirschberg (DE); Benjamin Kloepper, Mannheim (DE); Kalpesh Bhalodi, Zwingenberg (DE); Andreas Potschka, Goslar (DE); Dennis Janka, Heidelberg (DE)

(21) Appl. No.: 18/549,428

(22) PCT Filed: Mar. 12, 2021
(86) PCT No.: PCT/EP2021/056378

§ 371 Date: Sep. 7, 2023

(51) Int. Cl. G05B 19/418

(52) U.S. Cl. CPC G05B 19/41875; G05B 2219/32368

(57) ABSTRACT

A computer-implemented method is provided. The method includes receiving geological data of a material and processing data referring to a plurality of processing stations of an industrial process for manufacturing a product from the material; receiving, for the geological data and the processing data, corresponding product quality data of the manufactured product; and training or retraining a prediction model for the industrial process to determine predicted product quality data for the geological data and the processing data

Aspects of the invention relate to a computer-implemented method for training or retraining a prediction model for an industrial process, in particular a continuous industrial process such as a mining process. Further aspects relate to a computer-implemented method for predicting a product quality of the industrial process. Even further aspects relate to a system for performing the methods.

### TECHNICAL FIELD

Many industrial processes include a series of processing steps often performed separately at different processing stations, and logistical operations such as storage and transport of material between or within these stations. Control and monitoring of the production assets involved in the industrial process are often performed with specialized tools and methods.

While it is often possible to find optimal conditions for each separate operation within an industrial process such as mining, an optimization typically is based on a siloed view of each processing station or operation of the industrial process. This can result in conflicting operational strategies. A potential way to overcome this and other shortcomings is the creation of a material flow digital twin. A material flow digital twin can enable connectivity of assets within the process and improve the homogenization of data. However, in particular for large-scale industrial processes, the creation of a material flow digital twin can be challenging. Further, simulating all relevant processes of the industrial process using a material flow digital twin can be highly computational demanding. Therefore, reliably estimating a final product quality and/or other product parameters such as energy consumption, CO2 emission, and a tonnage for a running continuous industrial process such as mining is often not feasible, even if a sufficiently reliable model of the material source, e.g. the mine would be available, which is usually not the case. The final product quality is however an important parameter for efficiently running the industrial process which typically is desired to take into account typically changing boundary conditions and/or constrains such as the market commodity price for a product of the final product quality.

In view of the above, there is a need for reliably and efficiently predicting the final product quality another product attributes of a continuous industrial process, and optionally even a corresponding quantity of the final product such as an amount and/or tonnage of the final product. Thus, according to the independent claims, respective computer-implemented methods and a system for performing said methods are provided.

### SUMMARY

According to an aspect, a computer-implemented method includes receiving geological data of a material and processing data referring to a plurality of processing stations of a typically continuous industrial process for manufacturing a product from the material, receiving, for the geological data and the processing data, corresponding product quality data of the manufactured product; and training or retraining a prediction model for the industrial process to determine predicted product quality data for the geological data and the processing data (when used as input).

In other words, the (received) corresponding geological data of the material, processing data referring to the plurality of processing stations and product quality data may be used as primary datasets for training (or retraining) the prediction model to output (predicted) product quality data for an input of (respective) geological data and processing data. In the following, the computer-implemented method is also referred to as training method.

Note that the datasets may include respective data for a given time. In other embodiments, the datasets may include a time sequence of respective data.

As continuous process, the industrial process typically includes a respective material flow between the processing stations. Continuous, in the context of this disclosure, can be understood as a process involving a continuous flow of material within the process.

In one example, a processing station can receive material, process the material, and dispense the processed material. In another example, a processing station can transfer material. In yet another example, a processing station can store the material. Combinations of such processes in one processing station are possible.

The industrial process is typically a mine process (herein also referred to as mining process). Several aspects of the disclosure will be explained by illustration in the context of a mine process, however, the described method may be applicable for other types of continuous industrial processes including agricultural processes such as harvesting, food/beverage processing, chemical/pharmaceutical manufacturing, pulp and paper production, consumer good manufacturing, raw material processing, material reprocessing/recycling, metal processing, battery production, or semiconductor fabrication, and provide the described benefits for these types of industrial processes. The material flow of the process, particularly the mine process, can include, in one example, the transfer, transport and processing of ore, chemicals for processing, waste material, fuel, water or further materials.

The process, particularly a mine process, can include processing stations. Processing stations, in the sense of this disclosure, can be physical processing stations which process a material, e.g. ore processing stations such as crushers, mixers or the like. Processing stations, in the sense of this disclosure, can also be virtual stations that relate to the mine process by providing information about the mine process, such as planning stations, e.g. for geological planning, logistic planning, market integration or process planning. Processing stations, in the sense of this disclosure, can be physical operations with no permanent or stationary character, such as blasting for providing raw material, or the hauling or transport of material, e.g. via conveyors, trains, diesel or electric trucks, boats or such. Processing stations, in the sense of this disclosure, may also be stations which do not involve a chemical or mechanical processing of the material, such as warehouses or stockyards.

Typically, the prediction model is configured to determine/output the product quality data and/or one or more even general product attributes in real time, i.e. within less than about 1 s or even less than 0.5 s or even 0.2 s, or in near real-time, i.e. within less than about 10 s or even less than 5 s.

Accordingly, expected product quality data may be provided in short time. Thus, planning and/or even adapting the running manufacturing may be facilitated. In particular, long term planning of the exploitation, i.e. where to mine next week, next month, next year, mid-term production planning typically including how to exploit a specific area of a material resource (e.g. a mine) with which processing resource(s), and even short-term production planning including scheduling of operations and maintenance may be improved. As a result, the whole industrial process including the material flow may be better, faster and/or more reliably adapted in accordance with changing constraints. In particular, the final product quality of the industrial process may be better adapted to the expectation of customers. Note that higher product quality is usually acceptable, but may result in waste of resources and reduced efficiency, respectively, and may represent a lost opportunity, whereas lower quality products are usually not accepted by the customer, at least not at the agreed price. In this regard it is further noted that mining companies often use blending techniques close to the harbor (end of the value chain) to create a final product which just meets the expectations of the customer. However, this requires a huge stockyard close to the harbor with enough material for blending. Better planning can reduce the need for such stockyards. By using the methods and systems explained herein, time- and cost-intensive processing steps to meet the expectations as well as longer lead times between planning and shipping of the product may be reduced or even avoided. Accordingly, the industrial process can be performed more efficiently.

The prediction model is typically based on machine learning, in particular regression techniques, more particular linear regression or support vector machines (SVM) and/or deep learning. For example, the prediction model may be based on a deep neural network such as a recurrent neural network (RNN) which are particularly suited for sequences of input signals.

The term “neural network” (NN) as used in this specification intends to describe an artificial neural network (ANN) or connectionist system including a plurality of connected units or nodes called artificial neurons. The output signal of an artificial neuron is calculated by a (non-linear) activation function of the weighted sum of its inputs signal(s). The connections between the artificial neurons typically have respective weights (gain factors for the transferred output signal(s)) that are adjusted during one or more learning phases. Other parameters of the NN that may or may not be modified during learning may include parameters of the activation function of the artificial neurons such as a threshold. Often, the artificial neurons are organized in layers which are also called modules. The most basic NN architecture, which is known as a “Multi-Layer Perceptron”, is a sequence of so called fully connected layers. A layer consists of multiple distinct units (neurons) each computing a linear combination of the input followed by a nonlinear activation function. Different layers (of neurons) may perform different kinds of transformations on their respective inputs. Neural networks may be implemented in software, firmware, hardware, or any combination thereof. In the learning phase(s), a machine learning method, in particular a supervised, unsupervised or semi-supervised (deep) learning method may be used. For example, a deep learning technique, in particular a gradient descent technique such as backpropagation may be used for training of (feedforward) NNs having a layered architecture. Modern computer hardware, e.g. GPUs makes backpropagation efficient for many-layered neural networks. A recurrent neural network (RNN) is an ANN where connections between the neurons (nodes) form a directed graph along a temporal sequence. RNNs exhibit temporal dynamic behavior. One example is the so-called Long short-term memory (LSTM) used in the field of deep learning. LSTMs include feedback connections and can, depending on implementation, process single input signals, for example numbers, vectors or arrays for a given time, but also (time) sequences of such input signals. In particular, LSTMs may be used for classifying, processing and making predictions based on time series input signals.

The architecture of the prediction model, for example the network structure including the arrangement of neural network layers, the sequence of information processing in an NN, the number of input neurons, the number of output neurons, the number of hidden layers etc. typically depend on the industrial process and may be tuned accordingly. The architecture of the prediction model may be defined by so-called hyperparameters of the prediction model.

The term “parameter of the prediction model” as used herein intends to describe data of the prediction model that may be changed during training or retraining. For example, parameters of a neural network (prediction model) may be data representing or consisting of connection weights within fully connected layers and kernel weights within convolutional layers. The term “characterizing parameter set of the prediction model” as used herein intends to describe a set of data fully defining a specific implementation of the prediction model to be operable in software and/or hardware. For example, the characterizing parameter set of the prediction model may include and/or consist of all data that may be changed during training or retraining and hyperparameters of the prediction model.

Training and/or retraining may include using the geological data and the processing data as input of the prediction model (to be trained or retrained) to determine intermediate predicted product quality data, comparing the intermediate predicted product quality with the product quality data, and using the intermediate predicted product quality and the product quality data for changing at least one parameter of the prediction model.

The training or retraining may be performed at least once, typically iteratively.

The method may further include validating the trained or retrained prediction model.

For this purpose, second datasets not used for training (often called validation datasets) may be used to provide an unbiased evaluation of the fit provided by the prediction model on the training dataset while tuning the model's hyperparameters (e.g. the number of hidden neurons, layers and layer widths etc. for an NN).

Validation datasets may in particular be used for regularization by early stopping (stopping training when the error on the validation dataset increases, as this is a sign of overfitting to the training dataset) and or choosing/selecting a final prediction model.

Further, the method may include testing the trained or retrained prediction model, in particular the final prediction model.

In particular, further test datasets that have never been used before (often also referred to as holdout datasets) may be used to provide a final unbiased evaluation of the final model on the datasets.

If Further training (retraining) processes may be performed (offline) from time to time, typically using new datasets collected in the meantime.

Typically, a plurality of corresponding geological data, processing data and quality data are used for training or retraining the prediction model.

The geological data may be obtained from a (3d) mining model and/or are at least in part based on exploration. The geological data typically include a (source) location of the material used for manufacturing the product. Further, the geological data may include data referring to a physical and/or a chemical property of the material at the location such as composition that may be determined by exploration. However, obtaining these data is typically cumbersome. Therefore, geological data referring to physical and/or chemical properties of the material at the location may be sparse or even not present at all.

Nevertheless, the prediction model can be trained to reliably predict the product quality if sufficiently diverse trainings datasets (of the past) are used. In other words, the prediction model may learn during the training to interpolate and/or extrapolate the product quality only based on location information, processing data and quality data of the manufactured end-product.

The respective processing data may include a processing point of a processing station, a parameter of the processing station, and/or a (even a complete) processing configuration of the processing station.

Further, the processing data may be obtained from a digital twin of the industrial process, more particular a digital twin referring to the material flow including all processing steps of the material during the industrial process. The term “digital twin” as used herein shall embrace the terms “process digital twin” and “material flow digital twin”.

Accordingly, a plurality of corresponding datasets obtained in the past and stored within the digital twin may be retrieved and used as datasets for training, retraining, validating and/or testing the prediction model.

Note that a digital twin of an industrial process such as mining may process and store a huge amount of data delivered by many processing stations at comparatively high sampling rate. Accordingly, simulating the processes and estimating the product quality is tedious and often at least not feasible during runtime as this may require extremely high computing capacities on site and/or reliably power full data connections to a powerful cloud service and/or a computing center.

According to an aspect, a computer-implemented method includes receiving geological data of a material and processing data referring to a plurality of processing stations of a typically continuous industrial process for manufacturing a product from the material, and using the geological data and the processing data as input of a trained prediction model to output predicted product quality data. In the following this method is also referred to as prediction method.

Typically, the prediction method uses an instance of a prediction model trained with a corresponding training method as explained herein.

Unlike the training method, the prediction method is typically performed in real-time or near real time.

Further, the prediction method typically uses input data referring to a running industrial process.

Each processing station may be configured to dynamically provide processing data representing a state of the processing station. In particular, the processing data can be dynamically provided, such as when requested by an external receiver, periodically according to predefined intervals, or when certain predefined conditions apply, for example when a material batch has been successfully processed or when a material quality falls below a certain threshold.

The processing data representing the state of the processing station can include information on the material flow, such as current processing rate, material quality, power consumption, storage levels, customer orders, transfer speed between processing stations, truck or train schedules, or such. The data can be sensor data. The data can be derived from sensor data. The data can include planned states, such as expected tonnage or yields. The data can represent and/or include anticipated states, such as arrival times, e.g. arrival times derived from sending times. The data for the processing stations can be at least in part virtual. For some processing stations the data can be derived via calculations, e.g. using a soft sensor concept as described below.

In embodiments, in which the processing data include data referring to the amount of processed material such as the tonnage, the prediction model is typically also trained to predict the amount, more particular to output predicted (product quality) data (referring to product quality and product quantity) such as a predicted tonnage for the predicted product quality data and a predicted amount or tonnage of a produced/manufactured end product having the predicted end product quality (data).

Note that the term product quality data intends to embrace data referring to a quality of a product, in particular an end quality of the product, for example an end quality as specified in a contract with a customer. A such an amount of the end product quantity for a given quality, in particular a given end quality of the product is also to be considered as product quality data.

In other words, the product quality data may include corresponding data referring to a quantity of the material and/or the product, such as and amount of the material processed by a processing station of a quality and an amount or tonnage of the end product of a particular purity.

Output predicted product quality data (and/or the corresponding product quantity data) may be used for optimizing the manufacturing the product from the material, for example by searching for a Pareto optimal solution(s).

In embodiments referring to a mine process, processing data may refer to and/or be obtained from at least one of, more typically several or even all of the following processing stations blasting, hauling, storage, and ore processing. In addition, processing data may refer to and/or be obtained from planning and/or shipping.

Note that the above-mentioned process stations may include several sub-process stations that may also be considered as individual process stations (in a chain of process stations).

For example, hauling may include (sub-) process stations referring to (truck) transport of the material, pumping of water, conveyor belts and the like.

Further, ore processing stations may include (sub-) process stations referring to crushing, separating, concentrating and the like.

In embodiments referring to a mine process, the geological data typically include a respective source location of the material in a mine, in particular a source location of a geological material, more particular an ore.

As the trained prediction model can predict the outcome if the mine is operated in a specific way using mine content from a specific location, short-term production planning, mid-term production planning as well as long-term production planning can be improved by using the predicted product quality data as feedback information.

The respective product quality data may include and/or refer to an end quality of the product.

In particular, the respective product quality data (optionally including product quantity data corresponding to one or more of the product quality data) may include and/or refer to one or more quality indicators and key performance indicators (KPI), respectively. The indicators may be absolute values such as an amount of produced end product, an amount of produced waste, an amount of used energy or relative values such as a product purity, an amount of produced end product per time unit, an amount of produced waste per time unit (or per product unit), a used energy per time (or per product unit) and any combinations thereof, in particular ratios between indicators such as a ratio between the amount of produced end product (per time unit) and the amount of produced waste (per time unit).

More particular, the respective product quality data may include and/or refer to a quality indicator such as an amount of ore, an ore content, an amount of waste, a lead time, an energy consumption per product unit, an ecological foot print per product unit such as carbon dioxide production per product unit or water consumption per unit, a tonnage, and any combinations thereof.

The prediction method typically further includes using the output predicted product quality data for determining a recommendation for changing the process for manufacturing the product and/or for changing a planning of manufacturing the product, in particular with respect to a planned mining location.

Determining the recommendation typically includes using an explainable AI method that provides the reasoning for the recommendation.

Providing the reasoning for the recommendation can help building trust in the user operating and/or monitoring the industrial process compared to only providing the recommendation. This is because the reasoning (explanation for the recommendation) can provide transparency. Accordingly, the end user is able to make a more well-informed decision when they receive explanations in addition to the (otherwise “black box”) prediction.

Typically, the explainable AI method uses corresponding geological data, processing data, and the output predicted product quality data of the of the trained prediction model, and a characterizing parameter set of the trained prediction model for determining the recommendation.

For example, in embodiments referring to NN as prediction model, the different “weights” may be used to see which input features are given more importance. Based thereon, a reasoning may be determined.

In other embodiments, the trained prediction model is already configured to provide a recommendation, and typically also a reasoning for the recommendation (includes the feature of explainability).

One example refers to a method called “Teaching Explanations for Decisions (TED)” which can provide meaningful explanations matching a mental model of human users, but does not rely on feeding the output model (characterizing parameter set of the trained prediction model) and data to be explained to a separate “explainer” component or module. Rather, the training data may be augmented with explanation from e.g. a domain expert. Thereafter, the resulting trained prediction model can provide predicted product quality data as well as a recommendation and an explanation for the recommendation.

Providing the reasoning may include any of the known explanation methods, in particular feature attribution, for example local interpretable model-agnostic explanations (LIME), visualization, natural language processing and textual justification.

Further, the provided reasoning may refer to pre-modelling explainability, explainable modelling, and/or pre-modelling explainability.

Even further, the provided reasoning may refer to the data and/or the prediction model.

According to an embodiment, the geological data and the processing data are provided by a monitoring method and/or a digital twin of the industrial process.

The monitoring method may include one of, more typically several of or even all of the steps:
(a) providing, for each processing station, a processing station layout of the processing station, wherein the processing station layout comprises:
   a representation of a physical layout of the processing station, and
   a representation of material flow-paths to and from the processing station,
   wherein the processing station layout is configured for enabling a mapping of the material flow to and from the processing station,
(b) providing, for each processing station, an interface model of the processing station, wherein the interface model comprises:
a representation of data input ports and data output ports of the processing station,
wherein the interface model is configured for enabling a mapping of a data flow to the data input ports and from the data output ports of the processing station;
(c) generating an information metamodel from the processing station layout and the interface model of the processing stations, wherein the information metamodel is based on a markup language, in particular the international standard automation markup language, and/or comprises:
   a process layout model, the process layout model comprising the processing station layouts of the processing stations, and
   a process interface model, the process interface model comprising the interface models of the processing stations,
(d) generating an adaptive simulation model of the industrial process by importing the data representing the state of the processing station provided by the of processing stations into the adaptive simulation model via the information metamodel,
(e) storing the imported data, for example in a database or an event log file typically also storing the corresponding geological data, and
(f) outputting respective processing data, in particular in a predefined format suitable as input of the prediction model, typically using the stored data, the database, the event log file and/or the adaptive simulation model of the industrial process.

Typically, steps a) to c) are performed prior to runtime, while steps (d) to (f) may be performed during the running industrial process.

Further, the information metamodel and the adaptive simulation model are typically included in a digital twin of the industrial process.

Note that the processing data may also be output by the monitoring method and the digital twin, respectively, or provided by a separate planning tool.

The prediction method may further include providing feedback, in particular to the digital twin. Accordingly, the accuracy of the digital twin may be further improved.

More particular, the feedback may be used for iteratively improving the information metamodel and/or the simulation accuracy based on the information metamodel. The feedback can be provided in the form of a feedback loop. The feedback can involve defining an element to be varied within the information metamodel, and/or a value by which the defined element is to be varied. In one example, the analytics application can detect or simulate that a variation of one element of the industrial process, such as e.g. a throughput of a processing station, does not correspond to the observed variation and adapt the information metamodel to better represent the industrial process.

The output processing data may be used for generating of a key performance indicator (KPI) dashboard. The KPI dashboard can be a known key parameter dashboard, such as the Dashboard application for use with the ABB Ability™ Manufacturing Operations Management (MOM) Applications, or customer specific MES platforms, or the Dashboard included in the ABB Ability™ Analytics and Visualization Services, or the ABB Ability™ Genix industrial analytics and AI suite.

The output processing data may also be used for generating of a current operations monitor. The current operations monitor can include information on aspects of the industrial process, particularly material flow, processing station capacity, power usage and several such aspects. The current operations monitor can provide a visualization of the adaptive simulation model based on current results.

The output processing data may be used for generation of a future operations predictor. The future operations predictor can provide predictive analyses based on future timeframes.

The output processing data may be used for generating of a what-if analysis tool. The what-if analysis tool can simulate scenarios based on user-defined parameters and, for example, offer the possibility of initial value adjustment.

The processing station layout typically includes a representation of a physical layout of the processing station. In one example, the processing station can be a crusher, and the representation of the physical layout of the crusher can include the location of the crusher, the performance of the crusher, the connection with other components of the mine, e.g. a conveyor or a downstream machine, the power source of the crusher or such. If the processing station is a virtual or non-physical processing station, such as a planning stage or a logistic path, the representation of the physical layout of the processing station can be empty or undefined. The processing station layout further includes a representation of material flow-paths to and from the processing station. Material flow-paths can, in one example, include the type of expected material, the minimum or maximum amounts of material, the expected output material flow in dependence of the respective input material flow, the required time for processing the material or such. The representation of material flow-paths can be suitable for creating a material flow map of material between processing stations. The processing station layout enables a mapping of the material flow to and from each processing station. The mapped material flow typically does not represent the actual flow, i.e. transfer of material. The mapped material flow can be a mapped material flow-path, i.e. representing potential routes for the material, particularly between processing stations.

The interface model typically includes a representation of data input ports and data output ports of the processing station. Data input and output ports can be addresses of the processing station, particularly addresses for sending or receiving data, such as network addresses of the processing station. Data input and output ports can be configured for directed communication. The representation of data input and output ports can include target ports, e.g. of a further processing station, a controlling tool or an analysis tool or such. The input and output ports of the processing station can be the data ports through which the processing station provides the data representing the state of the processing station, as described above. In one example, the processing station is a crusher, and the data input and output ports are provided by a control module of the crusher, e.g. by a connection between the control module and a data network such as a local data network or the internet. The interface model enables a mapping of a data flow to the data input ports and from the data output ports of the processing station. The mapped data flow can be a list, map or model of the available data ports, i.e. addresses, of the respective processing station. The mapped data flow can include information about the type, structure, source, format, expected interval, and/or underlying sensor type of data, such that from the mapped data flow, the connectivity of the processing stations becomes clear. The mapped data flow can include further data for defining aspects of the mapped data flow. The mapped data flow typically does not represent exchanged data, but connectivity of processing stations, particularly of processing stations with other components of the industrial process, such as further processing stations.

The process layout model can be a model representing the layout of the industrial process, particularly in terms of processing stations within the industrial process, particularly including the aspects of the processing station layout as previously discussed. The process layout model includes the processing station layouts of the number of processing stations. The process layout model can include information representing links and/or connections between processing stations, such as material flow-paths. The links and/or connections can be a network of material flow-paths, and the process layout model can include a topology of the network of material flow-paths. Said links can be incorporated as elements within processing station layouts, or can be generated during the generation of the information metamodel.

The process interface model can be a model representing the layout of the industrial process, particularly in terms of data interfaces available within the industrial process, particularly including the aspects of the interface model of a processing station as previously discussed. The process interface model includes the interface models of the number of processing stations. The interface model can include information representing links and/or connections between processing stations, such as data connections, ports or addresses. Said links can be incorporated as elements within the interface model of the processing stations, or can be generated during the generation of the information metamodel.

Generating the information metamodel may be accomplished by utilizing exporters. Exporters can be tools, such as software tools, provided between the processing station and the information metamodel. Exporters can be configured for interpreting data provided by the processing station, such as by a control module of the processing station, e.g. as a log-file, as a data stream, or such, particularly via a data input or a data output port of the processing stations, such as the data input and data output ports described earlier. An exporter can provide the processing station layout of the processing station. An exporter can provide the interface model of the processing station. The exporter can be a resource type exporter for exporting the resource type of a resource, such as a processing station. The exporter can be a data model type exporter for exporting the data model type provided by a resource, such as a processing station, particularly a software or control module monitoring the processing station. Type exporters, such as resource type exporters or data model type exporters, can be used for building a type library of the processing stations within the industrial process. In one example, the type library can be built according to AutomationML's System Unit Class Libraries.

The exporter can be a process layout exporter for importing the layout of the industrial process into an instance model, the instance model comprising all instances, e.g. all processing stations, within the industrial process. The process layout exporter can, together with the type library of the processing stations within the industrial process, be utilized for building an instance model of the industrial process. The instance model can be included in the process layout model of the industrial process, i.e. the information metamodel. In one example, the instance model can be built according to AutomationML's Instance Hierarchy.

The exporter can further be a data value address exporter for importing a data value address, such as a representation of a data input port of a processing station. The data value address exporter can, in some examples, be a data value importer, providing the functionality of a data value address exporter but from the information metamodel, particularly an instance model included in the information metamodel, to the processing station. The data value address exporters and importers can be used for building a process interface model, such as the process interface model described earlier, included in the instance model and the information metamodel of the process.

Generating the information metamodel can include generating a type library from the processing station layout and the interface model of the number of processing station. Generating the type library can be performed by utilizing an exporter, as described earlier.

Further, generating the information metamodel can include generating an instance model comprising the processing station layout of at least one of the processing stations as defined by the type library. Generating the type library can be performed by utilizing an exporter, as described earlier.

Furthermore, generating the information metamodel can include generating an instance model comprising an interface model of at least one of the processing stations as defined by the type library. Generating the instance model can be performed by utilizing an exporter, as described earlier.

Even further, generating the information metamodel can include generating a process layout model and including the process layout model into the instance model by using a process layout exporter comprising the material flow-path to and from the at least one of the processing stations included in the instance model. Generating the process layout model can be performed by utilizing an exporter, as described earlier.

Further, generating the information metamodel can include importing data input ports for importing data representing the state of the processing station provided by the number of processing stations into the instance model. Importing the data input ports can be performed by utilizing an exporter, as described earlier.

Generating the information metamodel can include enabling a data flow between interfaces of the number of processing stations by using a data value exporter/importer linked via the instance model. The interfaces can be data ports of the processing stations, such as data input ports and data output ports. The data flow can be enabled such that it is still available for a significant duration after the creation of the information metamodel. Enabling the data flow between interfaces of the number of processing stations can include importers or exporters or a combination thereof, as described above.

Further, generating the adaptive simulation model of the industrial process typically includes importing the data representing the state of the processing station provided by the number of processing stations into the adaptive simulation model. The importing of the data is performed via the information metamodel. The information metamodel can function as a hub, e.g. for aggregating, routing, converting and transferring the data provided by the processing stations. Typically, the information metamodel does not directly hold data values, i.e. the information metamodel includes the relevant process layout together with the relevant process interface model, the process interface model defining from where data can be retrieved by the adaptive simulation model. In particular, the information metamodel can utilize the process layout model for providing a map of the processing stations within the process, and the physical connections between the processing stations, particularly material flow-paths. The process layout model can be utilized for mapping a material flow within the industrial process, particularly all possible material flows. The information metamodel can further utilize the process interface model for linking data provided by the processing stations to the process layout model. The information metamodel, particularly by utilizing the process interface model, can further be used for converting the data provided by the processing stations into a common and/or interchangeable format, particularly by using a number of exporters or importers as described above. The information metamodel can provide the data provided by the number of processing stations to the adaptive simulation model. The data provided to the adaptive simulation model via the information metamodel can be structured, linked, enhanced, formatted, marked-up or expanded such that the data provided by the number of processing stations can be evaluated, by the adaptive simulation model, in the context of the industrial process, particularly in the context of the process layout model, particularly in the context of the material flow-paths of the industrial process, and/or stored in a database that may be used for the training method as explained herein.

The adaptive simulation model can be adaptive. Adaptive, in the context of this disclosure, can include the property of the adaptive simulation model to respond to changes in the properties of the industrial process, such as such as changes in the data provided by the number of processing stations, which is to be expected at all times due to e.g. a change in operation parameters, as well as changes in the process layout model or the process interface model. A change in the process layout model or the process interface model can e.g. include the removal of a processing station due to maintenance, and a resulting change of material flow-paths to and from said processing station. The information metamodel and the adaptive simulation model can be configured for automatically re-evaluating the industrial process and generating a new information metamodel and/or a new adaptive simulation model.

The changes can be virtual to enable what-if analyses, e.g. introduce virtual changes, such as adding or removing virtual processing stations. In one example, an analysis can involve the addition of a virtual conveyor belt to assess the possible effect of adding the conveyor belt.

Providing adaptivity can include a selection of an appropriate simulation model from a library of simulation models. In one example, the model can be a previously generated model which best represents a current state of the industrial process. In another example, the chosen model can emphasize one aspect of the process more than another process, e.g. if an emphasis is put on optimizing a set of conveyors, an adaptive simulation model might be selected from the library of simulation models which simulates the set of conveyors with a higher resolution than other models. Selecting the appropriate adaptive simulation model from the library of adaptive simulation models may be performed automatically or as a result of user input.

After the generation of the adaptive simulation model using the data included in the information meta model, the adaptive simulation model can be initiated using status information of the number of processing stations of the industrial process provided by the information metamodel.

Furthermore, the adaptive simulation model can act as a “soft-sensor” to generate missing status information not provided by the information meta model, e.g. by simulating the missing data or by replacing the missing data with expected values, standard values or the likes. Simulating the missing data can involve the creation of a soft sensor to provide soft sensor data. The soft sensor data can then again be made available via the information metamodel to other applications.

The output processing data can be provided to an analytics application, such as one or a combination of the analytics application described above, and analysed by the analytics application. The analysed data can be utilized to provide feedback

As already explained above, the information metamodel and the adaptive simulation model can be comprised in a digital twin of the industrial process. In one example, the information metamodel and the adaptive simulation model together form a digital twin of the process. The digital twin can be a model of a system of components or a system of systems, such as a model of an industrial process comprising processing stations. The digital twin can be used to evaluate the current condition of the industrial process, and predict future behavior, optimize operation and refine control aspects of the industrial process. The digital twin can reflect the industrial process' current configuration, age and environment and/or material flow. Data of the industrial process, such as data provided by a number of processing stations, can, via the digital twin, be directly streamed into tuning algorithms or analytics applications, such as the analytics applications described above.

The interface model of each processing station can be configured for providing connectivity between the information metamodel and/or the adaptive simulation model and the processing station. In one example, the interface models of two processing stations can be configured for enabling, via the information metamodel and/or the adaptive simulation model, an exchange of information between two processing stations, or a higher number of processing stations, such as all processing stations included in the adaptive simulation model.

The process layout model can link (a number of) processing station layouts according to the material flow-paths between the processing stations. The linking of the processing stations according to the material flow-paths between the processing stations can result in a map of the network of material flow-paths. The processing stations can be nodes within the network of material flow-paths.

The process interface model of the information metamodel can link the data representing a state of the processing station provided by a processing station of the number of processing stations to the process layout model. In one example, the process interface model can be configured such that data sent from an outgoing data port can be correlated to an entity represented in the process layout model, such as a processing station. The correlation can be based on information comprised within the process interface model which links the data port, from which data was sent, to the entity represented in the process layout model.

The adaptive simulation model may be used to identify material blobs in the material flow and to export an event log file referring to the material blobs and representing the material flow. The material blobs can be virtual. A material blob can be a representation of an arbitrary amount of material within an industrial process, particularly a continuous industrial process. A material blob can be, in one example, an amount of material processed in a process between two arbitrary events, such as an amount of material processed between two timepoints. A material blob typically corresponds with a quantity of a real material (e.g. a truck load) having the same material properties. However, a material blob does not have to be separate from other material blobs with regards to material, process or such, i.e. two material blobs can represent the same charge or batch of material, e.g. relate to material processed at different timepoints but within the same process or processing station. A virtual material blob can be virtual in that the separation of one batch of material into material blobs does not mean a corresponding separation of the actual material into distinct batches corresponding to the blobs. A virtual material blob can further be a material blob that does not represent physical material, i.e. is entirely virtual, e.g. for simulating material flow, analysing the process, performing a what-if analysis or such.

The adaptive simulation model may provide an event log file referring to the material blobs and representing the material flow, particularly in the form of events related to material blobs. The event log file can include information corresponding to events in the industrial process. The event log file can be a file, a data stream, a transmission or such, i.e. the event log file does not need to be a file stored in a file system. The event log file can include information from which material blobs can be identified. The event log file can include information from which attributes of the material blobs can be correlated with the identified material blobs. The event log file can include key parameter indicators (KPIs) related to the material blobs. The KPIs can be KPIs as described above in relation to analytics applications. Attributes of the material blobs can correlate to attributes of the material from which the material blobs are derived. In one example, attributes of a material blob can include information such as material quality, quantity, energy spent for processing, history of the material blob or such.

Typically, the adaptive simulation model can provide the event log file in a unitary format, such that material blobs can be identified and tracked for different processing stations, particularly different types of processing stations, or different instances of processing stations of identical, similar or different types. Ideally, event logs provided by processing stations in different, e.g. process station specific file formats, can be converted and provided in a unitary format by the adaptive simulation model and/or an exporter. For this, the adaptive simulation model and the information metamodel can be utilized in a manner such as one described above.

Identifying material blobs and exporting the event log file referring to the material blobs can include pre-processing the event log file before processing the event log file. Pre-processing the event log file can be performed by the adaptive simulation model or a separate tool. Pre-processing the event log file can exclude unnecessary data and/or reformat the data in the log file. Excluding unnecessary data can include identifying the unnecessary data, i.e. according to a predefined set of rules, such as a program. Unnecessary data can be data that does not carry any information or redundant information, such as double entries. Unnecessary data can be data for which it is known that it cannot be evaluated, understood, parsed or otherwise processed or analyzed by a downstream application, such as an analytics application described above. Pre-processing the event log file can reformat the event log file such that it can be processed by a downstream application. Reformatting can include providing the event log file in a specific file format, such as in a specific markup language, such as JSON, XML, AutomationML or such, in particular a markup-language supported by a cloud provider, e.g. MS Azure. Accordingly, training the prediction model in a cloud is facilitated. Reformatting can include reformatting only parts of the event log file, e.g. parts of the event log file which do not correspond to a specified format. Reformatting can include providing the event log file in several different formats, such as a specific file format required for each downstream application.

Identifying material blobs and exporting the event log file referring to the material blobs can include processing the event log file with a process mining technique to generate a process map. Processing the event log file can include generating a process map. Processing the event log file can include providing, inputting or feeding the event log file into a tool for performing a process mining technique.

Processing the event log file can further include determining case identifiers required by the process mining technique. Case identifiers can be attributes of an event. Case identifiers can identify events and/or link events to entities referred to within the event log file, such as aspects relating to the material flow, particularly material blobs. Case identifiers can be identifiers of material blobs, such as unique identifiers.

Processing the event log file can further include filtering and/or reducing noise. Filtering and/or reducing noise can be performed together with pre-processing the event log file, or be performed in tandem, or be performed in a separate step. Typically, filtering and/or reducing noise is a separate function to pre-processing. Particularly, filtering and/or reducing noise can be a function or set of functions performed on the data level of the event log file, i.e. include an evaluation of data. Filtering the event log file can include filtering events that do not contain meaningful data, such as data that will not contribute to a more accurate description of a material blob, such as attributes that are redundant or are not included in the process map. Reducing noise can include reducing noise of the event log file, such as by filtering the event log file as described above. Reducing noise can further include aggregating multiple events into groups of events or single events, particularly if the frequency of an event is high compared to other events within the event log file. Filtering and/or reducing noise can, for example, include removing, condensing or grouping status events which only indirectly relate to material blobs, such as events that represent common sensor readings, such as e.g. a periodic temperature reading at a processing station.

According to a further aspect, a system is provided which is configured to perform one or more of the methods explained herein.

The system can be implemented in a computer or a number of computers, such as an offline machine, a computer network, a control station or the likes. The system can further comprise a cloud-based application, the cloud forming part of the system for performing the method.

According to an aspect, the system or components of the system, such as a computer, a cloud-based device or a processing station, may comprise a network interface for connecting the device to a data network, in particular a global data network. The data network may be a TCP/IP network such as Internet. The device, e.g. the processing station, is operatively connected to the network interface for carrying out commands received from the data network. The commands may include a control command for controlling the device to carry out a task such as performing an operation described herein in relation to the method. In this case, the device is adapted for carrying out the task in response to the control command. The commands may include a status request. In response to the status request, or without prior status request, the device may be adapted for sending a status information to the network interface, and the network interface is then adapted for sending the status information over the network. The commands may include an update command including update data. In this case, the device is adapted for initiating an update in response to the update command and using the update data.”

The data network may be an Ethernet network using TCP/IP such as LAN, WAN or Internet. The data network may comprise distributed storage units such as Cloud. Depending on the application, the Cloud can be in form of public, private, hybrid or community Cloud.

According to a further aspect, the device further comprises a network interface for connecting the device to a network, wherein the network interface is configured to transceive digital signal/data between the device and the data network, wherein the digital signal/data include operational command and/or information about the device or the network.

The system can include one or more processing stations. The processing stations can be processing stations as described herein, and include control modules, such as control modules capable of performing aspects of the method.

The methods and systems described herein allowing for improved predicting of product quality, monitoring and even controlling an industrial process, such as a mine process.

Advantages of the described methods and systems can be used to increase an efficiency and/or reducing of processing cost.

In particular, the output predicted product quality data, the recommendation, and/or the reasoning may be used for improving short-term production planning, mid-term production planning and/or long-term production planning.

Further advantages, features, aspects and details that can be combined with embodiments described herein are evident from the dependent claims, the description and the drawings.

### BRIEF DESCRIPTION OF THE FIGURES

The details will be described in the following with reference to the figures, wherein

FIG. 1 is a flow chart of a computer-implemented method according to an embodiment.

FIG. 2 is a flow chart of a computer-implemented method according to an embodiment.

FIG. 3 is a flow chart of a computer-implemented method according to an embodiment.

FIG. 4 is a flow chart of a computer-implemented method according to an embodiment.

FIG. 5 is a schematic view of a system for monitoring and operating an industrial process according to an embodiment.

FIG. 6 is a schematic view of a mine process representative for an industrial process as described herein.

FIG. 7 is a schematic view of a material blob representation within a processing station as described herein.

### DETAILED DESCRIPTION OF THE FIGURES AND OF EMBODIMENTS

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

In the given embodiments, a mine process is used as an example for illustrating the general aspects described above. The described method and system can be equally applicable for other types of industrial process.

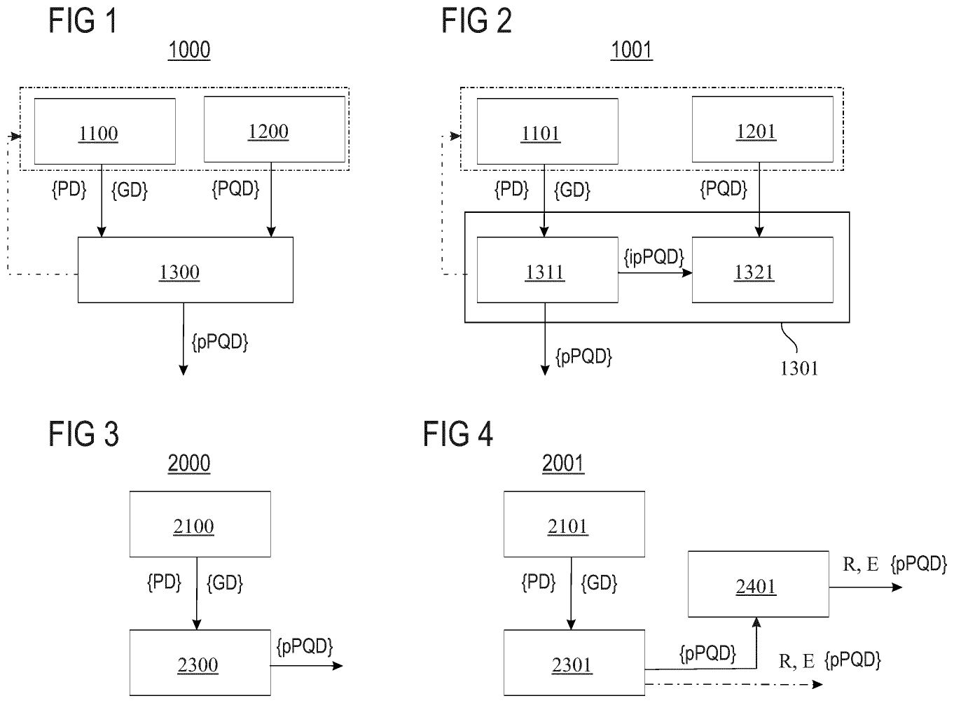

Referring to FIG. 1, an exemplary computer-implemented training method 1000 is explained.

In a block 1100, geological data {GD} of a material and processing data {PD} referring to a plurality of processing stations of an industrial process of manufacturing a product from the material.

The brackets { } shall indicate that the respective data may refer to several or even a plurality of respective data. However, the geological data {GD} may also only contain one location (source information, in particular a source location of the material for a respective time or time interval). Different thereto, the processing data typically include a plurality of processing data referring to a plurality of processing stations of the industrial process. The product quality data may include only one quality indicator such as a final product purity or a final ore content, or several of even a plurality of such indicators.

Note that the geological data {GD} and the processing data {PD} may also be a sequence of respective data typically including a time information (time stamp).

In a block 1200, product quality data {PQD} of the manufactured product which correspond to the geological data {GD} and processing data {PD} are received.

As indicated by the dashed-dotted rectangle in FIG. 1, geological data {GD}, processing data {PD} and product quality data {PQD} may be received in one block, e.g. as respective datasets {GD, PD, PQD}.

Thereafter, in a block 1300, the received data {GD}, {PD}, {PQD} may be used to train (or retrain) a prediction model for the industrial process to output predicted product quality data {pPQD} for input geological and processing data {GD}, {PD}.

As indicated by the dashed-dotted arrow in FIG. 1, training may be done iteratively using a plurality of data and datasets {GD, PD, PQD}, respectively.

Note that if enough datasets {GD, PD, PQD} are available for training, e.g. from a digital twin, the trained prediction model can be used for mapping geological data, in particular location data and processing data to resulting quality data.

Note further, that the trained prediction model may even be used to predict quality data for unmined areas.

Typically, the prediction result will be better the closer the location is to an already mined area or already mined areas and/or will become better if more training datasets {GD, PD, PQD} are available for training (the longer the mine is operated).

Accordingly, the typically tedious training method may be repeated regularly, from time to time in accordance with mining progress and/or if the output predicted product quality data {pPQD} deviate from measured values determined for the end product.

FIG. 2 illustrates a computer-implemented training method 1001 which is typically similar to training method 1000 and also includes respective blocks 1101, 1201 and 1301 referring to receiving geological data {GD} and processing data {PD}, receiving product quality data {PQD} and training a prediction model. However, block 1301 is more specific compared to block 1300.

In the exemplary embodiment, which can be combined with other embodiments described herein, the geological data {GD} and the processing data {PD} are used as input of the prediction model to determine intermediate predicted product quality data {ipPQD} in a block 1311.

Thereafter, the intermediate predicted product quality data {ipPQD} and the product quality data {PQD} may be used to change one or more parameters of the prediction model in a block 1301.

This may be based on a comparison of the intermediate predicted product quality data {ipPQD} and the product quality data {PQD}, e.g. based on a difference between the two values.

As explained above, prior to using the prediction model, further processes, in particular validating the prediction model, and/or testing the prediction model may be performed.

Referring to FIG. 3, an exemplary computer-implemented prediction method 2000 is explained.

In a block 2100, geological data {GD} of a material and processing data {PD} referring to a plurality of processing stations of an industrial process of manufacturing a product from the material are received.

Thereafter, the received geological data and processing data {GD}, {PD} may be used as input of a trained prediction model, in particular a prediction model trained with one of the methods 1000, 1001 explained above with regard to FIGS. 1, 2 to output predicted product quality data {pPQD}, in a block 2300.

The output predicted product quality data {pPQD} may be further processed and/or used for short-term production planning, mid-term production planning and/or long-term production planning.

FIG. 4 illustrates a computer-implemented predicting method 2001 which is typically similar to predicting method 2000 and also includes respective blocks 2101 and 2301 referring to receiving geological and processing data {GD}, {PD}, and determining the predicted product quality data {pPQD}, respectively, using a prediction model.

However, method 2001 additionally includes determining and outputting a recommendation R and a reasoning E for the recommendation R.

As indicated in FIG. 4, the output predicted product quality data {pPQD} may be used for determining the recommendation R and preferably also a reasoning E for the recommendation R, in a block 2410. Accordingly, block 2410 typically implements an explainable AI method.

Alternatively and as indicated by the dashed-dotted arrow in FIG. 4, recommendation R and preferably also reasoning E may already be provided by block 2310, for example if block 2310 implements a TED method.

The output predicted product quality data {pPQD}, recommendation R and reasoning E may be further processed and/or used for short-term production planning, mid-term production planning and/or long-term production planning.

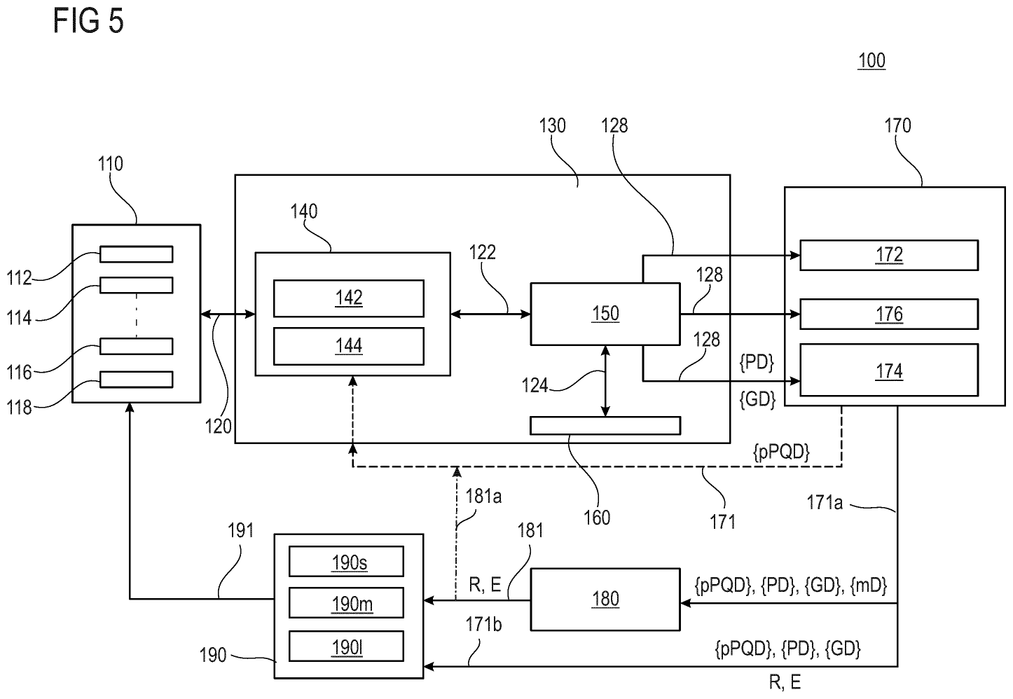

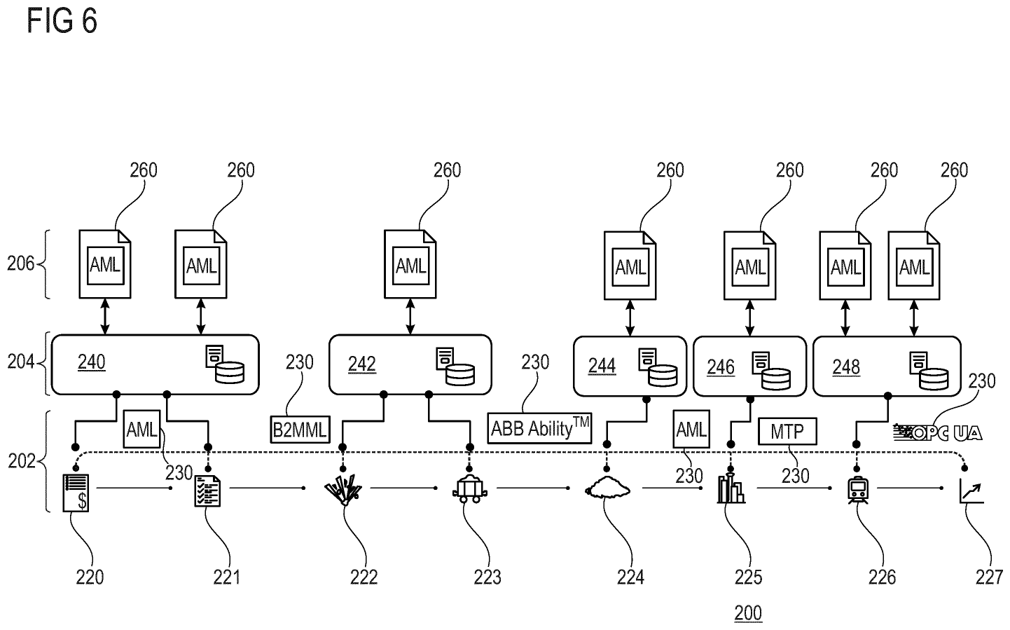

Referring to FIG. 5, according to an embodiment, a system 100 for monitoring and operating an industrial process is shown. The exemplary industrial process includes several processing stations (not shown, see also FIG. 6), each processing station comprising a controller. The controllers comprise a respective software, examples of which will be discussed in more detail with reference to FIG. 6. In the embodiment shown in FIG. 5, a mining software system 110, including software 112, software 114. software 116 and software 118 is provided. Mining software system 110 may include several subsystems each including one of the software 112-118. Each software 112-116 can be specific for the type of processing station, i.e. the software type can emphasize different aspects specific to the type of process performed by the processing station, include different interfaces, file or data formats etc. Software 118 may be a control or scheduling software for controlling software 112-116.

Exemplary system 100 includes a digital twin 130, particularly a process digital twin. The digital twin 130 is typically represented in the form of a data construct. Thus, digital twin 130 is typically comprised within a computer system or such. The digital twin 130 includes an information metamodel 140 and an adaptive simulation model 150.

In the exemplary embodiment, which can be combined with other embodiments described herein, the software system 110 is connected to the information metamodel 140 by an exporter/importer 120. The exporter/importer 120 exports data provided by the processing stations in a format that is compatible with the information metamodel 140, and imports data into the mining software system 110 in a format that is compatible with the respective software 112, 114, 116. Exporters/importers, such as exporter/importer 120, 122, 124 described herein, will sometimes be referred to only as exporter or importer, depending on their current function.

The exemplary information metamodel 140 includes a type library 142. The type library 142 includes data model entity types from all connected systems. In the shown embodiment, the type library 142 is generated by utilizing the exporter 120. The type library includes the data model entity types, particularly in the form of AutomationML System Unit Classes. The data model entity types are be based on the process layout model as derived from the respective processing station layout, and the process interface model derived from the interface models of the respective processing stations. The processing station layouts and the interface models of the processing stations are provided by the software 112, 114, 116 and processed by the exporter 120.

Further, the exemplary type library 142 can be built in a process referred to as type creation. Type creation can typically be performed as a first operation in building an information metamodel. Type creation typically is semi-automatic. Type creation can utilize the exporter 120. Type creation typically is only required once for a specific industrial process.

As illustrated in FIG. 5, the information metamodel 140 typically includes an instance model 144. The instance model 144 may include an instance hierarchy, particularly in the form of an AutomationML Instance Hierarchy. The instance hierarchy may include instances for all connected systems based on the types included in the type library 142. The instance model 144 may further include the process layout model and the interface model.

Further, the instance model 144 may include a representation of the industrial process, particularly representing the processing stations as instances of a type according to types within the type library 142. The instances may be modelled to be physically interconnected according to the process layout model, and/or connectively interconnected according to the process interface model.

Further, the instance model 144 may be built in a process referred to as instance creation. Instance creation can utilize the exporter 120. Instance creation can typically be performed automatically and thus quickly respond to changes in the industrial process, such as the layout of the industrial process, such as the removing or adding of processing stations.

Typically, the information metamodel 140 in combination with exporter/importer 120 can provide connectivity between software 112, 114, 116 even though the software using different data formats. For this, data from one software, e.g. software 112, is exported by exporter 120. The information metamodel 140 then provides connectivity between connected system 110, since the systems of the industrial process are included in the information metamodel, thus, data can be routed according to the information metamodel. The data is then provided by the importer 120 to, e.g. software 114, in a data format compatible with software 114.

Further, the digital twin 130 typically includes an adaptive simulation model 150. The adaptive simulation model 150 may be generated using the information metamodel 140 provided by exporter 122. The adaptive simulation model 150 may be selected from a simulation model library 160. Adaptions to the adaptive simulation model 150 and/or the simulation model library 160 may be performed, based on accuracy threshold requirements. The adaption can be performed with importer/exporter 124. The generation of the adaptive simulation 150 model can be semi-automatic.

Typically, the adaptive simulation model 150 includes live data connections to the processing stations, i.e. the mining software system 110, for receiving live data from the processing stations. The live data connection is provided by exporting the raw data of software system 110 and the software 112, 114, 116, respectively, with exporter 120 via the information metamodel 140 and exporter 122. The exported live data typically represents current states of the processing stations, which, due to contextualizing the data in the information metamodel, is provided in a homogeneous format and in the holistic context of the industrial process. The adaptive simulation model 150 can perform simulations of the industrial process according to the live data.

Further, the adaptive simulation model 150 typically provides the results of the simulation performed by the adaptive simulation model 150 to analytics applications 170 via exporter 128.

In particular, corresponding geological data {GD} and processing data {PD} may be provided via exporter 128.

Typically, the analytics application 170 includes a current operations monitor 172. The current operations monitor 172 utilizes live data to visualize current results. The current operations monitor 172 may benefit from an accurate simulation, thus, the adaptive simulation model 150 can be adapted to closely represent the current state of the industrial process.

Analytics application 170 may include a what-if analysis tool 176. The what-if analysis tool 176 can provide an analysis based on user-defined simulation scenarios and can offer the possibility of initial value adjustment. In one example, the what-if analysis tool 176 can utilize the results of the simulation of a current state by changing one or more parameters within the current state and simulating the industrial process according to the adaptive simulation model according to the current model with the changed parameters.

Analytics application 170 may further include a future operations predictor (not shown). The future operations predictor can provide predictive analyses for future timeframes. In one example, the future operations predictor can utilize the results of the simulation of future timeframes based on an extrapolation of a current state.

According to an embodiment, which can be combined with other embodiments described herein, the analytics application 170 can be or include a quality predictor 174 that can provide predicted product quality data {pPQD} for corresponding geological data {GD} and processing data {PD}.

According to an embodiment, which can be combined with other embodiments described herein, one or more of the analytics applications 170 can provide feedback to the digital twin 140 via a feedback line (importer/exporter) 171, particularly to the information metamodel 140. The feedback can include the predicted product quality data {pPQD} and/or information relating to differences between the observed live data and the simulation based on the live data, and be utilized for adapting, particularly improving or tuning the information metamodel.

In the exemplary embodiment, which can be combined with other embodiments described herein, system 100 further includes a recommender 180 which receives via a feedback line (exporter) 171a corresponding geological data {GD}, processing data {PD}, and output predicted product quality data {pPQD}, and a characterizing parameter set {mD} of the trained prediction model used for determining the predicted product quality data {pPQD} as input, and implements an explainable AI method to determine a corresponding recommendation R and optionally a reasoning (or explanation) E for the recommendation R. Note that the characterizing parameter set {mD} of the trained prediction model may only be once transferred to the recommender 180 (or after changing or retraining the prediction model).

In the exemplary embodiment, which can be combined with other embodiments described herein, system 100 further includes a planner (planning tool) 190 for an operator of system 100. Planner 190 typically includes a short-term planner 190s, a mid-term planner 190m, and a long-term planner 190m which at least receive via a feedback line (exporter) 171b the predicted product quality data {pPQD} as input.

Typically, planner 190 and planners 190s, 190m, 190l may also receive the recommendation R and optionally the reasoning E for the recommendation R as input from either recommender 180 (via feedback line (exporter) 181) or via feedback line (exporter) 171b when quality predictor 174 is configured to provide this information.

Further, planner 190 typically includes a visualisation unit (not shown) for presenting results of the planners 190s, 190m, 190l and the inputs.

Based on the results of the planners 190s, 190m, 190l, software system 110, in particular control or scheduling software 118 for controlling software 112-116 may receive feedback via feedback line (exporter) 191. Accordingly, operation of the industrial process may be amended in accordance with the results of planner 190.

As indicated by via feedback line (exporter) 181a, the recommendation R and optionally the reasoning E may also be provided as feedback to digital twin 130 for improving its accuracy.

Referring now to FIG. 6, a layer model of a mine process 200 is explained. The mine process can be an industrial process as described with regard to FIG. 5. The layer model 200 has three layers, with the first layer 202 corresponding to the physical aspects of the mine process. The mine process includes different stations, such as processing stations. The mine process includes a block model 220. The block model can be a block model of a mine and be utilized in a planning step. The mine process includes a planning station 221. The planning station 221 can be utilized for the planning of operations within the mine, such as blasting. The mine process includes blasting 222. Blasting can produce material, such as raw material, such as ore. The material is hauled in operation 223, and stored in a stockyard 224. The material is then processed in station 225, e.g. a processing station, shipped to a port 226 and sold on a market 227.

According to an embodiment, which can be combined with other embodiments described herein, the layer model 200 includes a second layer 204. The second layer 204 includes mine software, control systems, and edge systems. The second layer 204 systems are connected to the first layer systems for receiving data from the first layer 202 systems. The data can be provided from the first layer 202 systems to the second layer 204 in various file formats 230. The file formats may be specific to the first layer 202 system or the second layer 204 system, e.g. utilizing a common file format or an industry standard file format.

According to an embodiment, which can be combined with other embodiments described herein, the block model 220 and the planning station 221 can be connected to a geological planning software 240 for providing data from the block model 220 and the planning station 221 to the geological planning software 240. The data can be provided to the geological planning software 240 as an AML file.

According to an embodiment, which can be combined with other embodiments described herein, the blasting process 222 and the hauling process 223 can be connected to a knowledge manager 242, e.g. ABB Ability™ Knowledge Manager for mining and mineral processing, for providing data from the blasting process 222 and the hauling process 223 to the knowledge manager 242. The data can be provided to the knowledge manager 242 as an B2MML file, and/or in an ABB Ability™ file format.

According to an embodiment, which can be combined with other embodiments described herein, the stockyard 224 can be connected to a stockyard management system 244, e.g. ABB Ability™ Stockyard Management System, for providing data from the stockyard 224 to the stockyard management systems 244. The data can be provided to the stockyard management system 244 as an AML file, and/or in an ABB Ability™ file format.

According to an embodiment, which can be combined with other embodiments described herein, the processing station 225 can be connected to a control system 246, e.g. ABB Ability™ System 800xA, for providing data from the processing station 225 to the control system 246. The data can be provided to the control system 246 as an AML file, and/or an MTP file.

According to an embodiment, which can be combined with other embodiments described herein, the port 226 can be connected to other systems 248, e.g. third party systems, such as logistics systems, systems which have an economic focus or such, for providing data from the port 226 to the system 248. The data can be provided to the system 248 in a file format compatible with the system 248, such as an OPC UA file.

According to an embodiment, which can be combined with other embodiments described herein, the layer model 200 includes a third layer 206. The third layer 206 includes mine layouts and interface models. The mine layouts can be processing station layouts according to embodiments described herein. The interface models can be interface models of a processing station, according to embodiments described herein. In the embodiment shown in FIG. 6, the mine layouts and interface models are represented as AML files 260, wherein each file 260 includes the respective data of the underlying processing station. The files 260 can be configured for enabling the creation of an information metamodel, as described herein. Creation of the files 260 based on the data provided by the software of the second layer 204 can be performed by utilizing an exporter/importer, such as the exporter/importer 120 described in relation to the embodiment shown in FIG. 5.

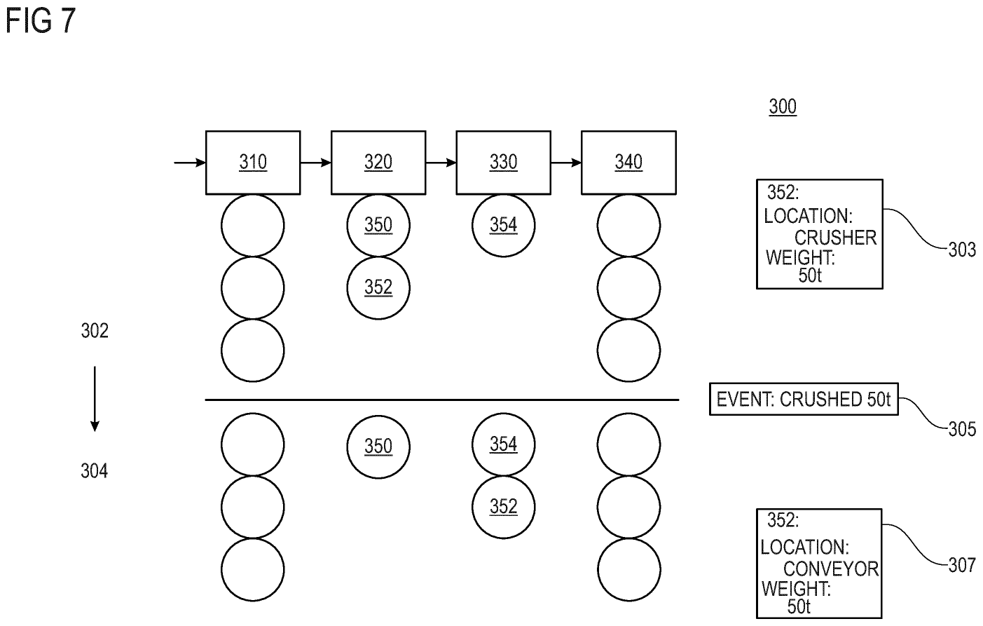

Referring now to FIG. 7, an example 300 for process mining an event log is shown. The event log can be an event log file provided by the digital twin, particularly adaptive simulation model according to an embodiment described herein. The process mining can be performed by an analysis application 170, such as a current operations monitor 172 described herein in relation to embodiment shown in FIG. 1.

In the example of FIG. 7, a processing station with a material flow is shown. The processing station is a crusher comprising a crusher input buffer 310, a crusher 320, a conveyor 330 and a stockpile 340. Two states of the processing station are shown, with state 302 being a first state and state 304 being a second state. Each state 302, 304 is represented as a number of material blobs, such as material blobs 350, 352 and 354. In the given example, the material blobs have already been identified and have attributes correlated thereto.

In the embodiment shown in FIG. 7, three material blobs are present in the input buffer 310, two material blobs 350, 352 are present in the crusher 320, one material blob 354 is present in the conveyor 330 and three material blobs are present in the stockpile 340.

In the example shown in FIG. 7, material blob 352 has, in the first state 302, the attributes 303. The attributes 303 include an identifier of the material blob (“352”), and the attributes “LOCATION: CRUSHER” and “WEIGHT: 50t”.

In the example shown in FIG. 7, the processing station performs a crushing operation and, e.g. after 50 t material have been processed, provides an event which can be, via the digital twin, included in an event log file. The event log file can be mined for events relating to one of the material blobs of the processing station, such as event 305. Event 305 includes information “EVENT: CRUSHED 50t”. Thus, from the event it is known that the state of the processing station has changed from state 302 to 304 and that a material blob with a weight of 50t has moved from the crusher to the conveyor. This material blob is identified as material blob 352, thus, the attributes 307 of material blob 352 at state 304 are changed to include “LOCATION: CONVEYOR”.

According to an embodiment, which can be combined with other embodiments described herein, the process mining operation of the example in FIG. 7 can be employed at all stages of an industrial process represented by a digital twin, and for various types of events relating to the material flow within the industrial process. Thus, a process map, based on a material flow within the industrial process, can be created. The process map can be utilized for visualizing the material flow within the process, and for obtaining statistical data of the process. Thus, deviations to standard operations can be more easily identified even for complex industrial processes, and the process can be optimized and better scheduled.

A number of embodiments and examples have been described. Nevertheless, it is understood that various modifications may be made without departing from the scope of the invention, which is defined by the claims that follow.

1. A computer-implemented method comprising:
receiving geological data of a material and processing data referring to a plurality of processing stations of an industrial process for manufacturing a product from the material;
receiving, for the geological data and the processing data, corresponding product quality data of the manufactured product; and
training or retraining a prediction model for the industrial process to determine predicted product quality data for the geological data and the processing data.

2. The method of claim 1, wherein training or retraining comprises at least one of:
using the geological data and the processing data as input of the prediction model to determine intermediate predicted product quality data;
comparing the intermediate predicted product quality data with the product quality data;
using the intermediate predicted product quality data and the product quality data for changing at least one parameter of the prediction model.

3. The method of claim 1, further comprising at least one of:
validating the trained or retrained prediction model; and
testing the trained or retrained prediction model.

4. The method of claim 1, wherein a plurality of corresponding geological data, processing data and quality data are used for training or retraining the prediction model, wherein the training or retraining is performed iteratively and/or at least once, wherein the geological data are obtained from a 3d mining model and/or are at least in part based on exploration.

5. A computer-implemented method comprising:
receiving geological data of a material and processing data referring to a plurality of processing stations of an industrial process for manufacturing a product from the material; and
using the geological data and the processing data as input of a trained prediction model to output predicted product quality data.

6. The method of claim 5, wherein the trained prediction model is obtained by a computer-implemented method comprising:
receiving geological data of a material and processing data referring to a plurality of processing stations of an industrial process for manufacturing a product from the material;
receiving, for the geological data and the processing data, corresponding product quality data of the manufactured product; and
training or retraining a prediction model for the industrial process to determine predicted product quality data for the geological data and the processing data.

7. The method of claim 5, wherein the geological data comprise a respective source location of the material in a mine, wherein the material is a geological material, and/or wherein the material is an ore.

8. The method of claim 5, wherein the industrial process is a mine process, and/or wherein processing data refer to and/or are obtained from at least one of the following processing stations:
planning,
blasting,
hauling,
storage,
ore processing, and
shipping.

9. The method of claim 5, wherein the respective processing data comprise at least one of a processing point of a processing station, a parameter of a processing station, and a processing configuration of a processing station.

10. The method of claim 5, wherein the respective product quality data comprise and/or refer to an end quality of the product.

11. The method of claim 5, wherein the respective product quality data comprise a quality indicator such as a product purity, an ore content, a lead time, an energy consumption per product unit and/or an ecological foot print per product unit such as a carbon dioxide production per product unit or a water consumption per unit.

12. The method of claim 5, wherein the prediction model is based on machine learning, in particular regression and/or deep learning.

13. The method of claim 5, further comprising:
using the output predicted product quality data for determining a recommendation for changing the process for manufacturing the product and/or for changing a planning for manufacturing the product, in particular with respect to a planned mining location.

14. The method of claim 13, wherein determining the recommendation comprises using an explainable AI method, typically further comprising at least one of:
using corresponding geological data processing data, and output predicted product quality data, and a characterizing parameter set of the trained prediction model as input of the explainable AI method; and
providing a reasoning for the recommendation.

15. The method of claim 14, wherein providing the reasoning comprises at least one of feature attribution, visualization, natural language processing and textual justification.

16. The method of claim 5, wherein at least one of the output predicted product quality data the recommendation (R), and the reasoning is used for short-term production planning, mid-term production planning and/or long-term production planning.

17. The method of claim 1, wherein each processing station is configured to dynamically provide processing data representing a state of the processing station, wherein the industrial process comprises a respective material flow between the processing stations, and/or wherein at least one of the geological data and the processing data are provided by a monitoring method of the industrial process for manufacturing the product, the monitoring method including at least one of:
providing, for each processing station, a processing station layout of the processing station, wherein the processing station layout includes:
a representation of a physical layout of the processing station, and
a representation of material flow-paths to and from the processing station,
wherein the processing station layout is configured for enabling a mapping of the material flow to and from the processing station;
providing, for each processing station, an interface model of the processing station, wherein the interface model includes:
a representation of data input ports and data output ports of the processing station,
wherein the interface model is configured for enabling a mapping of a data flow to the data input ports and from the data output ports of the processing station;
generating an information metamodel from the processing station layout and the interface model of the processing stations, wherein the information metamodel is based on a markup language, in particular the international standard automation markup language and/or includes:
a process layout model, the process layout model including the processing station layouts of the processing stations, and
a process interface model, the process interface model including the interface models of the processing stations,
generating an adaptive simulation model of the industrial process by importing the data representing the state of the processing station provided by the of processing stations into the adaptive simulation model via the information metamodel;
storing the imported data; and
outputting respective processing data, in particular in a predefined format suitable as input of the prediction model.

18. The method of claim 17, wherein the information metamodel and the adaptive simulation model are comprised in a digital twin of the industrial process.

19. The method of claim 18, further comprising:
providing feedback to the digital twin.

20. A system for performing a computer-implemented method comprising:
receiving geological data of a material and processing data referring to a plurality of processing stations of an industrial process for manufacturing a product from the material; and
using the geological data and the processing data as input of a trained prediction model to output predicted product quality data.
